(19) United States
(12) Patent Application Publication
(10) Pub. No.: US 2014/0310647 A1
(43) Pub. Date: Oct. 16, 2014

(54) METHOD FOR CONTROLLING INTERFACE AND TERMINAL THEREFOR

(71) Applicant: Tencent Technology (Shenzhen) Company Limited, Shenzhen (CN)

(72) Inventor: Lan Luan, Shenzhen (CN)

(73) Assignee: Tencent Technology (Shenzhen) Company Limited, Shenzhen (CN)

(21) Appl. No.: 14/251,435

(22) Filed: Apr. 11, 2014

Related U.S. Application Data
(63) Continuation of application No. PCT/CN2012/080310, filed on Aug. 17, 2012.

(30) Foreign Application Priority Data
Oct. 14, 2011 (CN) 201110311465.5

(51) Int. Cl. G06F 3/0481; G06F 3/0484

(52) U.S. Cl. CPC G06F 3/0481; G06F 3/04842
USPC 715/799

(57) ABSTRACT

The present disclosure, pertaining to the field of electronics technologies, discloses a method for controlling an interface and a terminal therefor. The method includes: acquiring an operation event of tapping a preset function button by a user; and controlling a toolbar on a local interface to be in a hidden state or displayed state according to the operation event of tapping the preset function button. According to the present disclosure, a preset function button is provided on an interface; a user is only required to tap the preset function button when a toolbar needs to be displayed or hidden, where no dragging on the interface is required. This reduces user's operations, and avoids the problem of conflicting with a touch gesture operation.

This application is a continuation application of International Application No. PCT/CN2012/080310, filed Aug. 17, 2012, which claims the benefit of priority to Chinese Patent Application No. 201110311465.5, filed on Oct. 14, 2011 and entitled “METHOD FOR CONTROLLING INTERFACE AND TERMINAL THEREFOR.” Each of these prior applications is incorporated herein by reference in its entirety.

### FIELD

The present disclosure relates to the field of electronics technologies, and in particular, to a method for controlling an interface and a terminal therefor.

### BACKGROUND

Currently, more and more mobile phones of various types are provided with touchscreens. A touchscreen mobile phone normally has a large and use-friendly touchscreen, and hence is becoming more and more popular. Users expect to display more contents required thereby on a size-limited touchscreen. For example, when a user reads an online novel over a touchscreen mobile phone, the user expects bigger text and more content to be displayed on one screen. Therefore, it would be better that some toolbars could be hidden and displayed where necessary, such that the user can view content on the full screen.

In the prior art, a toolbar is hidden on one side. When a user needs to use the toolbar, the user drags an interface until the user's finger reaches the edge of the interface, and then drags the interface again to display the hidden toolbar. Furthermore, after using the toolbar, the user may hide the toolbar by a reverse drag operation. For example, the interface is being dragged to the right when the toolbar needs to be displayed; correspondingly, the toolbar is being dragged to the left when the toolbar needs to be hidden.

During the implementation of the present disclosure, the inventor finds that the prior art has at least the following problems: When browsing a web page which extends out of a screen, the user needs to drag several screens to display the toolbar, and this increases the number of user's operations. Moreover, because the web page that is being browsed extends out of the screen, screen dragging needs to be performed for viewing content beyond the screen. Therefore, dragging the interface to the left (where the toolbar is located on the right) or right (where the toolbar is located on the left) to display the toolbar may conflict with a gesture operation on the browser (moving backward to the left or forward to the right).

### SUMMARY

In order to solve the problem in the prior art where the toolbar is displayed by performing dragging, embodiments of the present disclosure provide a method for controlling an interface and a terminal therefor. The technical solutions are as follows:

In one aspect, a method for controlling an interface when a browsing window is being dragged on a touchscreen of a mobile terminal is provided, including:

acquiring an operation event of tapping a preset function button by a user; and

controlling a toolbar on a local interface to be in a hidden or displayed state according to the operation event of tapping the preset function button.

The acquiring an operation event of tapping a preset function button by a user includes:

acquiring a tap operation event of the user;

judging whether the tap operation event is an operation for triggering the preset function button;

if yes, controlling the toolbar on the local interface to be in the hidden state or displayed state; and

otherwise, performing an operation specified by the tap operation event.

The judging whether the tap operation event is an operation for triggering the preset function button includes:

acquiring a function area on which the user tap operation is performed;

judging whether the function area is within an operation area of the preset function button; and

if yes, determining that the tap operation event is the operation for triggering the preset function button.

The controlling a toolbar on a local interface to be in a displayed state according to the operation event of tapping the preset function button includes:

if the toolbar on the local interface is in the hidden state, displaying the toolbar on the local interface according to the operation event of tapping the preset function button.

The controlling an operation state of a toolbar on a local interface according to the operation event of tapping the preset function button includes:

if the toolbar on the local interface is in the displayed state, hiding the toolbar on the local interface according to the operation event of tapping the preset function button.

In another aspect, a terminal is provided, including:

an acquiring module, configured to acquire an operation event of tapping a preset function button by a user when a browsing window is being dragged on a touchscreen of a mobile terminal; and

a controlling module, configured to control a toolbar on a local interface to be in a hidden or displayed state according to the operation event of tapping the preset function button.

The acquiring module includes:

an acquiring unit, configured to acquire a tap operation event of the user; and

a judging unit, configured to: judge whether the tap operation event is an operation for triggering the preset function button; if yes, control the toolbar on the local interface to be in the hidden state or displayed state; and otherwise, perform an operation specified by the tap operation event.

The judging unit is specifically configured to:

acquire a function area on which the user tap operation is performed; judge whether the function area is within an operation area of the preset function button; and if yes, determine that the tap operation event is the operation event for triggering the preset function button.

The controlling module includes:

a first controlling unit, configured to: if the toolbar on the local interface is in the hidden state, display the toolbar on the local interface according to the operation event of tapping the preset function button.

The controlling module includes:

a second controlling unit, configured to: if the toolbar on the local interface is in the displayed state, hide the toolbar on the local interface according to the operation event of tapping the preset function button.

The technical solutions provided in the present disclosure achieve the following beneficial effects: A preset function button is provided on an interface; a user only needs to tap the preset function button to display or hide a toolbar, and in this case, no dragging on the interface is required. This reduces user's operations, and avoids the problem of conflicting with a touch gesture operation.

### BRIEF DESCRIPTION OF THE DRAWINGS

For a better understanding of the technical solutions in the embodiments of the present disclosure, the accompanying drawings for illustrating the embodiments are briefly described below. Apparently, the accompanying drawings in the following description illustrate only some embodiments of the present disclosure, and persons of ordinary skill in the art may derive other accompanying drawings based on these accompanying drawings without any creative efforts.

FIG. 1 is a flowchart of a method for controlling an interface according to an embodiment of the present disclosure;

FIG. 2 is a flowchart of a method for controlling an interface according to another embodiment of the present disclosure;

FIG. 3 is a schematic diagram of controlling a toolbar using a function button according to the embodiment shown in FIG. 2 of the present disclosure; and

FIG. 4 is a schematic diagram of a terminal according to yet another embodiment of the present disclosure.

### DETAILED DESCRIPTION

To make the objectives, technical solutions, and advantages of the present disclosure clearer, the embodiments of the present disclosure are described in detail below with reference to the accompanying drawings.

Referring to FIG. 1, one embodiment of the present disclosure provides a method for controlling an interface when a browsing window is being dragged on a touchscreen of a terminal, including:

101: acquiring an operation event of tapping a preset function button by a user; and

102: controlling a toolbar on a local interface to be in a hidden state or displayed state according to the operation event of tapping the preset function button.

The acquiring an operation event of tapping a preset function button by a user includes:

acquiring a tap operation event of the user;

judging whether the tap operation event is an operation for triggering the preset function button;

if yes, controlling the toolbar on the local interface to be in the hidden state or displayed state; and

otherwise, performing an operation specified by the tap operation event.

In this embodiment, the judging whether the tap operation event is an operation for triggering the preset function button includes:

acquiring a function area on which the terminal user tap operation is performed;

judging whether the function area is within an operation area of the preset function button; and

if yes, determining that the tap operation event is the operation for triggering the preset function button.

Furthermore, the controlling a toolbar on a local interface to be in a displayed state according to the operation event of tapping the preset function button includes:

if the toolbar on the local interface is in the hidden state, displaying the toolbar on the local interface according to the operation event of tapping the preset function button.

Furthermore, the controlling a toolbar on a local interface to be in a hidden state according to the operation event of tapping the preset function button includes:

if the toolbar on the local interface is in the displayed state, hiding the toolbar on the local interface according to the operation event of tapping the preset function button.

This embodiment according to the present disclosure achieves the following beneficial effects: A preset function button is provided on an interface; a user only needs to tap the preset function button to display or hide a toolbar, and in this case, no dragging on the interface is required. This reduces user's operations, and avoids the problem of conflicting with a touch gesture operation.

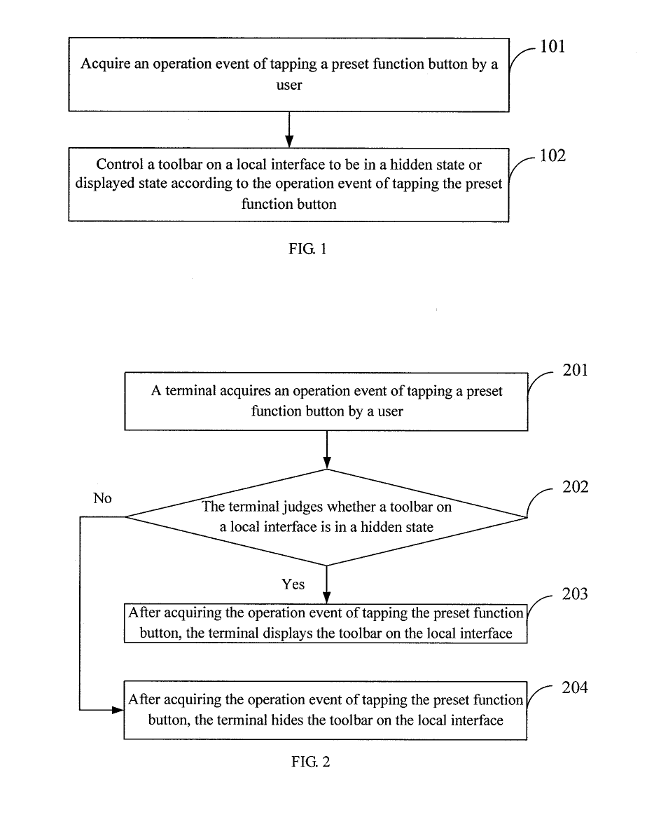

Referring to FIG. 2, another embodiment of the present disclosure provides a method for controlling an interface when a browsing window is being dragged on a touchscreen of a terminal, including:

201: A terminal acquires an operation event of tapping a preset function button by a user.

In this embodiment, the terminal may be a mobile phone or a mobile device having a touchscreen, such as an e-book reader or a personal digital assistant, which is not specifically limited in this embodiment. In this embodiment, an explicit operation entry is provided on a display interface of the touchscreen terminal. Specifically, a function button may be set, where the preset function button is used to guide the user in controlling an operation state of the toolbar by tapping the preset function button. In this embodiment, the operation state of the toolbar includes a displayed state and a hidden state. This enables the user to perform operations smoothly on the touchscreen, thereby improving user experience.

In this embodiment the acquiring an operation event of tapping a preset function button by a user includes:

1) acquiring, by the terminal, a tap operation event of the user;

2) judging whether the tap operation event is an operation for triggering the preset function button; and

3) if yes, continuing to perform 202; otherwise, performing the operation specified by the tap operation event. For example, if the user performs an operation that does not trigger the preset function button, for example, a tap and drag operation, the tap and drag operation of the user is performed.

Specifically, the judging whether the tap operation event is the operation for triggering the preset function button includes: acquiring a function area in which the terminal user tap operation is performed; judging whether the function area is within an operation area of the preset function button; and if yes, determining that the tap operation event is the operation for triggering the preset function button. In this embodiment, the preset function button may be provided at any position on the touchscreen interface. Preferably, in order to protect the user from being affected when using the terminal, the preset function button may be provided on an upper left corner, upper right corner, lower left corner, or lower right corner. Furthermore, the position of the preset function button may also be adjusted according to user preference. For example, the preset function button may be dragged from the upper right corner to the upper left corner, which is not specifically limited in this embodiment.

202: The terminal judges whether a toolbar on a local interface is in a hidden state; if yes, step 203 is performed; otherwise, step 204 is performed.

In this embodiment, the terminal, after acquiring the event of tapping the preset function button, further needs to judge the operation state of the toolbar. The user is aware of the operation state of the toolbar when performing the operation; however, the terminal further needs to, upon receiving the triggering, judge the existing operation state of the toolbar. For example, in a control area of the terminal, if a state item of the toolbar indicates “1”, the toolbar is in the hidden state; if “0” is indicated, the toolbar is in the displayed state. Hence, the terminal acquires the state item of the toolbar after acquiring the trigger event of tapping the preset function button; learns whether the toolbar is in the hidden state or displayed state according to the indication of the state item of the toolbar; and then performs a further operation.

203: After acquiring the operation event of tapping the preset function button, the terminal displays the toolbar on the local interface.

In this embodiment, if the existing state of the toolbar is the hidden state, the toolbar is popped out so that the toolbar is displayed on the interface. The toolbar may be displayed on any side of four sides of the terminal interface, which is not specifically limited in this embodiment.

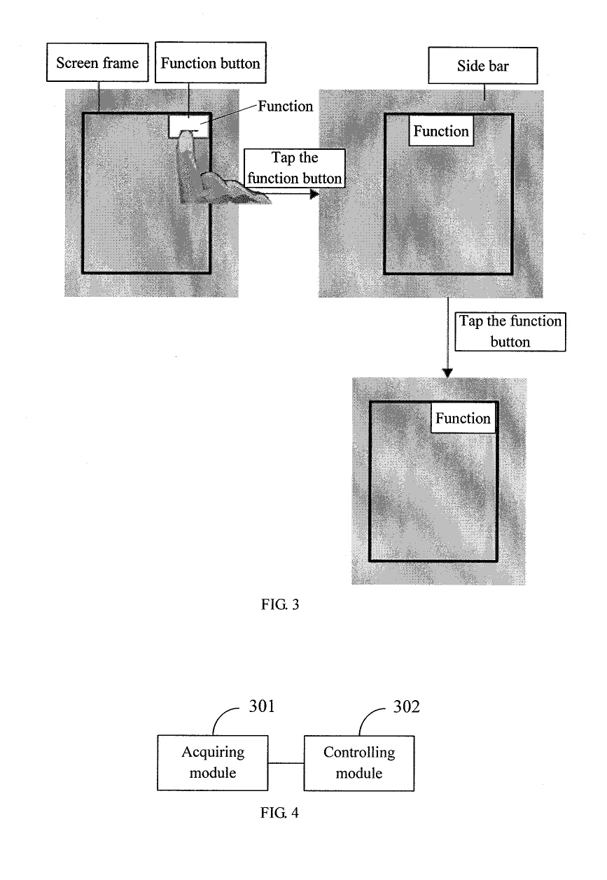

In this embodiment, after the toolbar is popped out, if the toolbar conflicts with the displayed preset function button, as shown in FIG. 3, where the function button is provided on the upper left corner, and the toolbar is displayed on the right side of the terminal interface after the function button is tapped, the pop-up toolbar interferes with the displayed function button. In such cases, the function button may further move relatively to the left along with the pop-up toolbar, so as to ensure that the toolbar and the function button do not interfere with each other.

204: After acquiring the operation event of tapping the preset function button, the terminal hides the toolbar on the local interface.

In this embodiment, if the existing state of the toolbar is the displayed state, the toolbar is hidden. Meanwhile, if the function button is moved when the toolbar is popped up, after the toolbar is hidden, the function button may return to the original position thereof.

Steps 202 to 204 are the process of controlling the operation state of the toolbar on the local interface according to the operation event of tapping the preset function button.

This method embodiment according to the present disclosure achieves the following beneficial effects: A preset function button is provided on an interface; a user only needs to tap the preset function button to display or hide a toolbar, and in this case, no dragging on the interface is required. This reduces user's operations, and avoids the problem of conflicting with a touch gesture operation.

Referring to FIG. 4, yet another embodiment of the present disclosure provides a terminal, including an acquiring module 301 and a controlling module 302.

The acquiring unit 301 is configured to acquire an operation event of tapping, by a user, a preset function button when a browsing window is being dragged on a touchscreen of the terminal.

The controlling module 302 is configured to control a toolbar on a local interface to be in a hidden state or displayed state according to the operation event of tapping the preset function button.

The acquiring module 301 includes:

an acquiring unit, configured to acquire a tap operation event of the user; and

a judging unit, configured to: judge whether the tap operation event is an operation for triggering the preset function button; if yes, control the toolbar on the local interface to be in the hidden state or displayed state; and otherwise, perform an operation specified by the tap operation event.

In this embodiment, the judging unit is specifically configured to:

acquire a function area on which the terminal user tap operation is performed; judge whether the function area is within an operation area of the preset function button; and if yes, determine that the tap operation event is the operation event for triggering the preset function button.

The controlling module 302 includes:

a first controlling unit, configured to: if the toolbar on the local interface is in the hidden state, display the toolbar on the local interface according to the operation event of tapping the preset function button.

Furthermore, the controlling module includes:

a second controlling unit, configured to: if the toolbar on the local interface is in the displayed state, hide the toolbar on the local interface according to the operation event of tapping the preset function button.

This device embodiment according to the present disclosure achieves the following beneficial effects: A preset function button is provided on an interface; a user only needs to tap the preset function button to display or hide a toolbar, and in this case, no dragging on the interface is required. This reduces user's operations, and avoids the problem of conflicting with a touch gesture operation.

The terminal provided in this embodiment is specifically based on the same inventive concept as the method embodiments. Therefore, the specific implementation can refer to the description of the method embodiments of the present disclosure, which is not described herein any further.

It should be noted that, the terminal provided in this embodiment is described by using the division of the functional modules as an example. In actual application, the functions may be performed by different functional modules according to actual requirements. That is, the internal structure of the terminal is divided into different functional modules to implement all or a part of functions described above.

A person skilled in the art should understand that all or part of steps of the preceding methods may be implemented by hardware or hardware following instructions of programs. The programs may be stored in a non-transitory computer-readable storage medium and may be executed by at least one processor. The storage medium may be a read-only memory, a magnetic disk, or a compact disc-read only memory.

Described above are merely preferred embodiments of the present disclosure, but are not intended to limit the present disclosure. Any modification, equivalent replacement, or improvement made without departing from the spirit and principle of the present disclosure should fall within the protection scope of the present disclosure.

What is claimed is:

1. A method for controlling an interface when dragging a browsing window on a touchscreen of a terminal, comprising:
acquiring an operation event of tapping a preset function button by a user; and
controlling a toolbar on a local interface to be in a hidden state or displayed state according to the operation event of tapping the preset function button.

2. The method according to claim 1, wherein the acquiring an operation event of tapping a preset function button by a user comprises:
acquiring a tap operation event of the user; judging whether the tap operation event is an operation for triggering the preset function button; if yes, controlling the toolbar on the local interface to be in the hidden state or displayed state; and otherwise, performing an operation specified by the tap operation event.

3. The method according to claim 2, wherein the judging whether the tap operation event is an operation for triggering the preset function button comprises:
acquiring a function area on which the user tap operation is performed; judging whether the function area is within an operation area of the preset function button; and if yes, determining that the tap operation event is the operation for triggering the preset function button.

4. The method according to claims 1, wherein the controlling a toolbar on a local interface to be in a displayed state according to the operation event of tapping the preset function button comprises:
if the toolbar on the local interface is in the hidden state, displaying the toolbar on the local interface according to the operation event of tapping the preset function button.

5. The method according to claim 1, wherein the controlling a toolbar on a local interface to be in a hidden state according to the operation event of tapping the preset function button comprises:
if the toolbar on the local interface is in the displayed state, hiding the toolbar on the local interface according to the operation event of tapping the preset function button.

6. A terminal, comprising:
an acquiring module, configured to acquire an operation event of tapping a preset function button by a user when a browsing window is being dragged on a touchscreen of the terminal; and
a controlling module, configured to control a toolbar on a local interface to be in a hidden state or displayed state according to the operation event of tapping the preset function button.

7. The terminal according to claim 6, wherein the acquiring module comprises:
an acquiring unit, configured to acquire a tap operation event of the user; and
a judging unit, configured to judge whether the tap operation event is an operation for triggering the preset function button; if yes, control the toolbar on the local interface to be in the hidden state or displayed state; and otherwise, perform an operation specified by the tap operation event.

8. The terminal according to claim 7, wherein the judging unit is specifically configured to:
acquire a function area on which the user tap operation is performed; judge whether the function area is within an operation area of the preset function button; and if yes, determine that the tap operation event is the operation for triggering the preset function button.

9. The terminal according to claim 6, wherein the controlling module comprises:
a first controlling unit, configured to: if the toolbar on the local interface is in the hidden state, display the toolbar on the local interface according to the operation event of tapping the preset function button.

10. The terminal according to claim 6, wherein the controlling module comprises:
a second controlling unit, configured to: if the local interface is in the displayed state, hide the toolbar on the local interface according to the operation event of tapping the preset function button.
